(19) United States
(12) Patent Application Publication
(10) Pub. No.: US 2014/0287011 A1
(43) Pub. Date: Sep. 25, 2014

(54) ARTHROPOD PEST CONTROL COMPOSITION

(71) Applicants: SUMITOMO CHEMICAL COMPANY, LIMITED, Tokyo (JP); Kyoyu Agri Co., Ltd., Kawasaki-shi, Kanagawa (JP)

(72) Inventors: Katsuya Natsuhara, Tokyo (JP); Yusuke Kimura, Nagano-shi (JP); Mamoru Takiuchi, Nagano-shi (JP)

(21) Appl. No.: 14/351,333

(22) PCT Filed: Nov. 2, 2012
(86) PCT No.: PCT/JP2012/079053

§ 371 Date: Apr. 11, 2014

(30) Foreign Application Priority Data
Nov. 4, 2011 (JP) 2011-242556

(51) Int. Cl. A01N 25/00; A01N 43/76

(52) U.S. Cl. CPC A01N 25/00; A01N 43/76
USPC 424/405; 514/374; 548/237

(57) ABSTRACT

Disclosed is an arthropod pest control composition comprising 2-(2,6-difluorophenyl)-4-[4-(1,1-dimethylethyl)-2-ethoxyphenyl]-4,5-dihydrooxazole and an inert carrier, wherein the volume median diameter of 2-(2,6-difluorophenyl)-4-[4-(1,1-dimethylethyl)-2-ethoxyphenyl]-4,5-dihydrooxazole is from 1.5 to 5.9

### TECHNICAL FIELD

The present application was filed claiming the priority of the Japanese Patent Application No. 2011-242556; the entire contents of which are herein incorporated by the reference.

The present invention relates to .an arthropod pest control composition, specifically an arthropod pest control composition comprising 2-(2,6-difluorophenyl)-4-[4-(1,1-dimethylethyl)-2-ethoxyphenyl]-4,5-dihydrooxazole.

### BACKGROUND

The compound 2-(2,6-difluorophenyl)-4-[4-(1,1-dimethylethyl)-2-ethoxyphenyl]-4,5-dihydrooxazole:

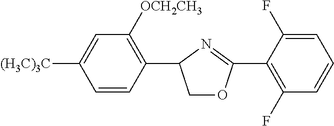 [SMILES: CCOc1cc(C(C)(C)C)ccc1C1COC(c2c(F)cccc2F)=N1]

is known to have a control activity on arthropod pests (see, for example, Patent literature 1).

### CITATION LIST

### Patent Literature

Patent literature 1: U.S. Pat. No. 5,478,855

### SUMMARY OF INVENTION

### Technical problem

An object of the present invention is to provide an arthropod pest control composition containing the above compound having a control activity on arthropod pests, which exhibits better control effect on arthropod pests.

### Solution to Problem

The present inventors have intensively studied for providing an arthropod pest control composition containing 2-(2,6-difluorophenyl)-4-[4-(1,1-dimethylethyl)-2-ethoxyphenyl]-4,5-dihydrooxazole having a control activity on arthropod pests, which exhibits better control effect on arthropod pests, and finally found that a composition comprising particles of the above compound having a certain limited size, i.e., 2-(2,6-difluorophenyl)-4-[4-(1,1-dimethylethyl)-2-ethoxyphenyl]-4,5-dihydrooxazole having a volume median diameter of from 1.5 to 5.9 μm and an inert carrier exhibits extremely superior properties, thereby attaining the present invention.

The present invention includes the following [1] to [12]:

[1] An arthropod pest control composition comprising 2-(,6-difluorophenyl)-4-[4-(1,1-dimethylethyl)-2-ethoxyphenyl]-4,5-dihydrooxazole and an inert carrier, wherein the volume median diameter of 2-(2,6-difluorophenyl)-4-[4-(1,1-dimethylethyl)-2-ethoxyphenyl]-4,5-dihydrooxazole is from 1.5 to 5.9 μm.
[2] The composition according to the above [1], wherein the volume median diameter of 2-(2,6-difluorophenyl)-4-[4-(1,1-dimethylethyl)-2-ethoxyphenyl]-4,5-dihydrooxazole is from 2.7 to 5.9 μm.
[3] The composition according to the above [1] or [2], wherein the inert carrier is a water-containing carrier.
[4] An aqueous suspension-type arthropod pest control composition comprising from 1 to 20% by weight of 2-(2,6-difluorophenyl)-4-[4-(1,1-dimethylethyl)-2-ethoxyphenyl]-4,5-dihydrooxazole, from 66 to 76% by weight of water, and from 6 to 23% by weight of a suspension agent, wherein the volume median diameter of 2-(2,6-difluorophenyl)-4-[4-(1,1-dimethylethyl)-2-ethoxyphenyl]-4,5-dihydrooxazole is from 1.5 to 5.9 μm.
[5] The composition according to the above [4], wherein the volume median diameter of 2-(2,6-difluorophenyl)-4-[4-(1,1-dimethylethyl)-2-ethoxyphenyl]-4,5-dihydrooxazole is from 2.7 to 5.9 μm.
[6] A method for controlling an arthropod pest, which comprises applying the composition according to any one of the above [1] to [5] in an effective amount for controlling the arthropod pest to the arthropod pest or a habitat of the arthropod pest.
[7] An aqueous suspension-type arthropod pest control agent comprising from 1 to 20% by weight of 2-(2,6-difluorophenyl)-4-[4-(1,1-dimethylethyl)-2-ethoxyphenyl]-4,5-dihydrooxazole, from 66 to 76% by weight of water, and from 6 to 23% by weight of a suspension agent, wherein the volume median diameter of 2-(2,6-difluorophenyl)-4-[4-(1,1-dimethylethyl)-2-ethoxyphenyl]-4,5-dihydrooxazole is from 1.5 to 5.9 μm.

[8] An aqueous suspension-type arthropod pest control agent comprising from 1 to 20% by weight of 2-(2,6-difluorophenyl)-4-[4-(1,1-dimethylethyl)-2-ethoxyphenyl]-4,5-dihydrooxazole, from 66 to 76% by weight of water,. and from 6 to 23% by weight of a suspension agent, wherein the volume median diameter of 2-(2,6-difluorophenyl)-4-[4-(1,1-dimethylethyl)-2-ethoxyphenyl]-4,5-dihydrooxazole is from 2.7 to 5.9 μm.
[9] Use of 2-(2,6-difluorophenyl)-4-[4-(1,1-dimethylethyl)-2-ethoxyphenyl]-4,5-dihydrooxazole having a volume median diameter of from 1.5 to 5.9 μm for controlling an arthropod pest by applying an aqueous suspension-type composition comprising said compound suspended in water to the arthropod pest or a habitat of the arthropod pest.
[10] Use of 2-(2,6-difluorophenyl)-4-[4-(1,1-dimethylethyl)-2-ethoxyphenyl]-4,5-dihydrooxazole having a volume median diameter of from 1.5 to 5.9 μm.
[11] Use of 2-(2,6-difluorophenyl)-4-[4-(1,1-dimethylethyl)-2-ethoxyphenyl]-4,5-dihydrooxazole having a volume median diameter of from 2.7 to 5.9 μm for controlling an arthropod pest by applying an aqueous suspension-type composition comprising said compound suspended in water to the arthropod pest or a habitat of the arthropod pest.
[12] Use of 2-(2,6-difluorophenyl)-4-[4-(1,1-dimethylethyl)-2-ethoxyphenyl]-4,5-dihydrooxazole having a volume median diameter of from 2.7 to 5.9 μm.

### Effects of Invention

According to the present dnvention, an arthropod pest control composition comprising 2-(2,6-difluorophenyl)-4-[4-(1,1-dimethylethyl)-2-ethoxyphenyl]-4,5-dihydrooxazole and having superior properties can be provided. Therefore, the present invention is useful for controlling an arthropod pest.

### Description of Embodiments

The arthropod pest control composition of the present invention is a composition comprising 2-(2,6-difluorophenyl)-4-[4-(1,1-dimethylethyl)-2-ethoxyphenyl]-4,5-dihydrooxazole and an inert carrier, wherein the volume 3-5-median-meter of 2-(2,6-dffluorophenyl)-4-[4-(1,1-dimethylethyl)-2-ethoxyphenyl]-4,5-dihydrooxazole is from 1.5 to 5.9 μm (hereinafter referred to as “the present composition”).

The compound 2-(2,6-difluorophenyl)-4-[4-(1,1-dimethylethyl)-2-ethoxyphenyl]-4,5-dihydrooxazole (hereinafter referred to as “the present oxazole compound”) to be used in the present invention can be prepared by, for example, a method described in U.S. Pat. No. 5,478,855. According to U.S. Pat. No. 5,478,855, the present oxazole compound can be obtained as a crystal having a melting point of from 101.0 to 102° C. The solubility of the present oxazole compound is 75.4 pg per 1 liter of water at 20° C.

The present oxazole compound to be used in the present invention has a volume median diameter of from 1.5 to 5.9 μm. The present oxazole compound having a volume median diameter of from 1.5 to 5.9 μm can be prepared by pulverizing the present oxazole compound in crystalline form having a volume median diameter higher than from 1.5 to 5.9 μm, by, for example, a dry pulverizing method such as impact crushing (e.g., hammer mill) and airflow milling (e.g., jet mill) or a wet pulverizing method such as bead mill methods.

The “volume median diameter” in the present invention is a value calculated by analyzing the image of a large number of particles measured by laser light diffraction scattering based on Mie scattering theory. Specific examples of the measuring apparatus for the volume median diameter include MASTERSIZER 2000 (manufactured by Malvern), SALD-1100 (manufactured by Shimadzu Corporation), and MICROTRAC MT3000 (manufactured by NIKKISO CO.).

The particle diameter and particle size distribution measured by the above measuring apparatus refers to a particle size distribution on a volume basis on the assumption that the measured particles are spherical. Therefore, the volume median diameter (VMD) in the present invention is a diameter wherein a total volume of the particles having a larger or smaller diameter than the VMD is each 50% relative to the total volume of the measured particles.

The present oxazole compound to be used in the present invention has a volume median diameter of from 1.5 to 5.9 μm, thereby showing superior control effect on arthropod pests. When the present composition is an aqueous suspension-type composition, the volume median diameter of the present oxazole compound is preferably from 2.7 to 5.9 μm from the viewpoint of the stability of the composition.

The inert carrier to be contained in the present composition includes solid carriers and liquid carriers, which can keep the volume median diameter of the present oxazole compound stable.

Examples of the solid carrier include a powdered or granulated solid carrier such as clays (kaolin clay, diatomaceous earth, synthetic silicon oxide hydrate, bentonite, Fubasami clay, acid clay, and the like), talc, ceramic, other inorganic minerals (sericite, quartz, sulfur, activated charcoal, calcium carbonate, hydrated silica, and the like).

Examples of the liquid carrier include water, alcohols (methanol, ethanol, and the like), ketones (acetone, methyl ethyl ketone, and the like), aromatic hydrocarbons (benzene, toluene, xylene, ethylbenzene, methylnaphthalene, and the like), aliphatic hydrocarbons (hexane, cyclohexane, kerosene, light oil, and the like), esters (ethyl acetate, butyl acetate, and the like), nitriles (acetonitrile, isobutyronitrile, and the like), ethers (diisopropyl ether, dioxane, and the like), acid amides (N,N-dimethylformamide, N,N-dimethylacetamide, and the like), halogenated hydrocarbons (dichloromethane, trichloroethane, carbon tetrachloride, and the like), dimethyl sulfoxide, and vegetable oils (soybean oil, cottonseed oil, and the like). Among the liquid carriers, preferred is water in which the present oxazole compound is difficult to be dissolved.

In the present composition, the content of the present oxazole compound having a volume median diameter of from 1.5 to 5.9 μm is not particularly limited, but is generally from 0.1 to 80% by weight, preferably from 1 to 75% by weight, relative to the total amount of the present composition, and the content of the inert carrier is not particularly limited, but is generally from 20 to 99.9% by weight, preferably from 25 to 99% by weight, relative to the total amount of the present composition.

In addition to the present oxazole compound having a volume median diameter of from 1.5 to 5.9 μm and the inert carrier, the present composition may further contain dispersing agents, suspension agents and other formulation additives (e.g., antifoaming agents, corrosion inhibitors, stabilizing agents, spreading agents, penetration aids, antifreezing agents, antimicrobial agents and antifungal agents). Examples of the suspension agent include protective colloids such as gelatin, casein, gums, cellulose ethers and polyvinyl alcohol, and thixotropic agents such as bentonite, magnesium aluminum silicate, xanthan gum and polyacrylic acid.

When the inert carrier contained in the present composition is a water-containing carrier, the present composition is preferably an aqueous suspension-type composition further containing the above suspension agent for keeping the present oxazole compound having a volume median diameter of from 1.5 to 5.9 μm suspended in the composition.

In the aqueous suspension-type composition, the content of the present oxazole compound having a volume median diameter of from 1.5 to 5.9 μm is generally from 0.1 to 30% by weight, preferably'from 1 to 20% by weight, the content of water is generally from 30⁻to 98.9% by weight, preferably from 66 to 76% by weight or from 66 to 74% by weight, and the content of the suspension agent is generally from 1 to 40% by weight, preferably from 6 to 23% by weight, relative to the total amount of the composition.

The aqueous suspension-type composition can be prepared by mixing water and the suspension agent with the present oxazole compound before or after the pulverization of the present oxazole compound to a volume median diameter of from 1.5 to 5.9 um by the above pulverizing method. The aqueous suspension-type composition can be also prepared by diluting a solid formulation (e.g., wettable powders and water , dispersible granules), which is preliminarily prepared by a general formulation method such that it can be suspended in water.

The aqueous suspension-type composition obtained by the above method and the like may be used as an aqueous suspension-type arthropod pest control agent without dilution or after dilution with water in a conventional method used in the agrochemical field for controlling arthropod pests.

The method for controlling an arthropod pest of the present invention comprises applying the present composition to the arthropod, pest or a habitat of the arthropod pest.

Examples of the habitat of. arthropod pest include plant-growing places such as paddies, fields, forests and orchards. The amount of the present composition to be applied to these plant-growing places is generally from 1 to 1000 grams, preferably from 10 to 100 grams per 1000 m² of the plant-growing place as the amount of the present oxazole compound having a volume median diameter of from 1.5 to 5.9 μm. Examples of the application method include foliage application to -a plant to be protected from arthropod pests, and soil application to the soil of the plant-growing place.

When the present composition is used for controlling an arthropod pest, the present composition can be used without dilution or after dilution with a liquid carrier such as water. When the present composition is used for controlling an arthropod pest, the present oxazole compound having a volume median diameter of from 1.5 to 5.9 μm can be generally used in a diluted solution at a concentration of from 10 to 1000 ppm.

The aqueous suspension-type composition of the present invention can be used for controlling arthropod pests such as pest insects and ticks. Specific Examples of the arthropod pest include the followings: Phytophagous mites: Tetranychus urticae, Tetranychus cinnabarinus, Tetranychus kanzawai, Panonychusulmi and Panonychus citri, etc.

### EXAMPLES

Hereinafter, the present invention will be described in more detail with reference to Preparation Example and test examples, but not limited thereto.

In the Examples, the volume median diameter of the present oxazole compound was measured by a laser diffraction particle size analyzer SALD-1100 (manufactured by Shimadzu Corporation).

Preparation examples will be shown below.

### Preparation Example

In a Three-One motor (manufactured by Shinto Scientific Co., Ltd.), 10 parts by weight of the present oxazole compound, 4 parts by weight of a polyoxyethylene allyl phenyl ether phosphate amine salt (Product name: NEWKALGEN FS-3, manufactured by TAKEMOTO OIL & FAT CO., LTD), 4 parts by weight of ethylene glycol, 0.5 parts by weight of a silicone emulsion (antifoaming agent, Product name: PRONAL EX-300, manufactured by TOHO Chemical Industry Co., Ltd.) and 66.4 parts by weight of water were mixed. Then, to the mixture were added glass beads having a diameter of from 1.0 to 1.41 mm, and the mixture was wet-pulverized with a bead mill (Product name: Dyno-mill, manufactured by SHINMARU ENTERPRISES Corporation) and filtrated to obtain a pulverized product. To the pulverized product were added 15 parts by weight of xanthan gum (Product name: Rhodopol 23, manufactured by Rhodia Nicca) and 0.1 parts by weight of an antifungal preservative (1,2-benzisothiazolin-3-one, Product name: Proxel GXL; manufactured by ICI Japan) and the mixture was mixed in a Three-One motor (manufactured by Shinto Scientific Co., Ltd.) to obtain an aqueous suspension-type composition.

In accordance with the above Preparation Example, various aqueous suspension-type compositions containing the present oxazole compound having different volume median diameters were prepared. The number of each Preparation Example and the volume median diameter of the present oxazole compound contained in the aqueous suspension-type composition obtained in each Preparation Example are shown in [Table 1].

TABLE 1

| Composition No. | Volume median diameter [μm] |
|---|---|
| Preparation Example 1 | 1.5 |
| Preparation Example 2 | 2.7 |
| Preparation Example 3 | 2.9 |
| Preparation Example 4 | 4.5 |
| Preparation Example 5 | 5.9 |
| Comparative Example 1 | 0.19 |
| Comparative Example 2 | 0.46 |
| Comparative Example 3 | 1.1 |
| Comparative Example 4 | 7.7 |
| Comparative Example 5 | 11 |
| Comparative Example 6 | 14 |

Test examples will be shown below.

### Test Example 1

Each of the aqueous suspension-type compositions obtained in Preparation Examples was diluted to 50 ppm of the present oxazole compound with water. An enough amount of each diluted suspension was applied to the foliage of the seedlings of apple (variety name: Hokuto) by a portable power sprayer. Twenty-three (23) days after the application, the leaves of the apple seedlings were cut and placed on absorbent cotton dampened with water in a petri dish having a diameter of 9 cm. Ten (10) female adults of Tetranychus kanzawai were released onto the leaves and then allowed to stand at room temperature. One (1) day after the release of the adults of Tetranychus kanzawai, the released adults were removed from the leaves while keeping eggs laid on the surface of the leaves. The eggs were allowed to stand at room temperature for 7 days. The umbers of the hatched larvae and the unhatched eggs of Tetranychus kanzawai were counted, and then the egg-killing rate was calculated by the following Equation 1.

Egg-killing rate (%)={Number of unhatched eggs/(Number of hatched larvae+Number of unhatched eggs)}×100 [Equation 1]

The results are shown in [Table 2].

TABLE 2

| | Volume median | Egg-killing |
|---|---|---|
| Composition No. | diameter [μm] | rate [%] |
| Preparation Example 1 | 1.5 | 100 |
| Preparation Example 3 | 2.9 | 100 |
| Preparation Example 5 | 5.9 | 94 |
| Comparative Example 2 | 0.46 | 51 |
| Comparative Example 6 | 14 | 22 |

### Test Example 2

The aqueous suspension-type composition obtained in Preparation Example 5 was diluted to 15 ppm of the present oxazole compound with water. To the foliage of potted seedlings of Chinese citron (variety name: Kawanonatsudaidai), 50 ml of the diluted suspension was applied. Four (4) weeks after the application, the leaves of the Chinese citron seedlings were cut and placed on absorbent cotton dampened with water in a petri dish having a diameter of 9 cm. Ten (10) female adults of Panonychus citri were released onto the leaves and then allowed to stand in artificial weather control equipment (atmosphere temperature 25° C., humidity 70%, light condition: light period 16 hours, dark period 8 hours). Three (3) days after the release of the adults of Panonychus citri, the released adults were removed from the leaves while keeping eggs laid on the surface of the leaves. The eggs were allowed to stand for further 9 days in the artificial weather control equipment (atmosphere temperature 25° C., humidity 70%, light condition: light period 16 hours, dark period 8 hours). After that, the numbers of the hatched larvae and the unhatched eggs of Panonychus citri were counted, and then the egg-killing rate was calculated by the above Equation 1.

As a result, the egg-killing rate was 99% as shown in [Table 3].

TABLE 3

| | Volume median | Egg-killing |
|---|---|---|
| Composition No. | diameter [μm] | rate [%] |
| Preparation Example 5 | 5.9 | 99 |

### Test Example 3

The viscosity of the aqueous suspension-type composition obtained in each Preparation Example was measured by B-type viscometer (rotor No. 2, 12 rpm) at room temperature. After that, each aqueous suspension-type composition was stored at -20° C. for 20 days. After the storage, the viscosity of each aqueous suspension-type composition was measured in the same manner as above.

From the viscosities of each aqueous suspension-type composition before and after the storage, the rate of change in viscosity was calculated by the following Equation 2.

Rate of change in viscosity (%)={(B-A)/A}×100 [Equation 2]

A: viscosity of aqueous suspension-type composition before storage at −20° C.

B: viscosity of aqueous suspension-type composition after storage at −20° C. for 20 days

The results are shown in [Table 4]. The closer the rate of change in the viscosity of an aqueous suspension-type composition is to 0%, the stronger the suppression of time-dependent change of the viscosity of the aqueous suspension-type composition is, i.e., the higher the storage stability of the aqueous suspension-type composition is.

TABLE 4

| | Volume median | Rate of change |
|---|---|---|
| Composition No. | diameter [μm] | in viscosity [%] |
| Preparation Example 2 | 2.7 | −1 |
| Preparation Example 4 | 4.5 | 4 |
| Comparative Example 1 | 0.19 | 10 |
| Comparative Example 3 | 1.1 | 8 |
| Comparative Example 5 | 11 | 10 |

1. An arthropod pest control composition comprising 2-(2,6-difluorophenyl)-4-[4-(1,1-dimethylethyl)-2-ethoxyphenyl]-4,5-dihydrooxazole and an inert carrier, wherein the volume median diameter of 2-(2,6-difluorophenyl)-4-[4-(1,1-dimethylethyl)-2-ethoxyphenyl]-4,5-dihydrooxazole is from 1.5 to 5.9 μm.

2. The composition according to claim 1, wherein the volume median diameter of 2-(2,6-difluorophenyl)-4-[4-(1,1-dimethylethyl)-2-ethoxyphenyl]-4,5-dihydrooxazole is from 2.7 to 5.9 μm.

3. The composition according to claim 1-er-2, wherein the inert carrier is a water-containing carrier.

4. An aqueous suspension-type arthropod pest control composition comprising from 1 to 20% by weight of 2-(2,6-difluorophenyl)-4-[4-(1,1-dimethylethyl)-2-ethoxyphenyl]-4,5-dihydrooxazole, from 66 to 76% by weight of water, and from 6 to 23% by weight of a suspension agent, wherein the volume median diameter of 2-(2,6-difluorophenyl)-4-[4-(1,1-dimethylethyl)-2-ethoxyphenyl]-4,5-dihydrooxazole is from 1.5 to 5.9 μm.

5. The composition according to claim 4, wherein the volume median diameter of 2-(2,6-difluorophenyl)-4-[4-(1,1-dimethylethyl)-2-ethoxyphenyl]-4,5-dihydrooxazole is from 2.7 to 5.9 μm.

6. A method for controlling an arthropod pest, which comprises applying the composition according to any one of claims 1 to 5 claim 1 in an effective amount for controlling the arthropod pest to the arthropod pest or a habitat of the arthropod pest.

7. An aqueous suspension-type arthropod pest control agent comprising from 1 to 20% by weight of 2-(2,6-difluorophenyl)-4-[4-(1,1-dimethylethyl)-2-ethoxyphenyl]-4,5-dihydrooxazole, from 66 to 76% by weight of water, and from 6 to 23% by weight of a suspension agent, wherein the volume median diameter of 2-(2,6-difluorophenyl)-444-(1,1-dimethylethyl)-2-ethoxyphenyl1-4,5-dihydrooxazole is from 1.5 to 5.9 μm.

8. An aqueous suspension-type arthropod pest control agent comprising from 1 to 20% by weight of 2-(2,6-difluorophenyl)-4-[4-(1,1-dimethylethyl)-2-ethoxyphenyl]-4,5-dihydrooxazole, from 66 to 76% by weight of water, and from 6 to 23% by weight of a suspension agent, wherein the volume median diameter of 2-(2,6-difluorophenyl)-4-[4-(1,1-dimethylethyl)-2-ethoxyphenyl]-4,5-dihydrooxazole is from 2.7 to 5.9 μm.

9. Use of 2-(2,6-difluorophenyl)-4-[4-(1,1-dimethylethyl)-2-ethoxyphenyl]-4,5-dihydrooxazole having a volume median diameter of from 1.5 to 5.9 μm for controlling an arthropod pest by applying an aqueous suspension-type composition comprising said compound suspended in water to the arthropod pest or a habitat of the arthropod pest.

10. Use of 2-(2,6-difluorophenyl)-4-[4-(1,1-dimethylethyl)-2-ethoxyphenyl]-4,5-dihydrooxazole having a volume median diameter of from 1.5 to 5.9 μm.

11. Use of 2-(2,6-difluorophenyl)-4-[4-(1,1-dimethylethyl)-2-ethoxyphenyl]-4,5-dihydrooxazole having a volume median diameter of from 2.7 to 5.9 μm for controlling an arthropod pest by applying an aqueous suspension-type composition comprising said compound suspended in water to the arthropod pest or a habitat of the arthropod pest.

12. Use of 2-(2,6-difluorophenyl)-4-[4-(1,1-dimethylethyl)-2-ethoxyphenyl]-4,5-dihydrooxazole having a volume median diameter of from 2.7 to 5.9 μm.

13. The composition according to claim 2, wherein the inert carrier is a water-containing carrier.

14. A method for controlling an arthropod pest, which comprises applying the composition according to claim 2 in an effective amount for controlling the arthropod pest to the arthropod pest or a habitat of the arthropod pest.

15. A method for controlling an arthropod pest, which comprises applying the composition according to claim 3 in an effective amount for controlling the arthropod pest to the arthropod pest or a habitat of the arthropod pest.

16. A method for controlling an arthropod pest, which comprises applying the composition according to claim 4 in an effective amount for controlling the arthropod pest to the arthropod pest or a habitat of the arthropod pest.

17. A method for controlling an arthropod pest, which comprises applying the composition according to claim 5 in an effective amount for controlling the arthropod pest to the arthropod pest or a habitat of the arthropod pest.
